(19) United States
(12) Patent Application Publication
(10) Pub. No.: US 2026/0019929 A1
(43) Pub. Date: Jan. 15, 2026

(54) Communication of Query Management-Frame Content

(71) Applicant: Apple Inc., Cupertino, CA (US)

(72) Inventors: Jarkko L Kneckt, Los Gatos, CA (US); Anuj Batra, Redwood City, CA (US); Neelakantan Nurani Krishnan, San Diego, CA (US); Pooya Monajemi, Sunnyvale, CA (US); Yong Ho Seok, Cupertino, CA (US); Yong Liu, Campbell, CA (US)

(21) Appl. No.: 19/261,391

(22) Filed: Jul. 7, 2025

Related U.S. Application Data
(60) Provisional application No. 63/669,292, filed on Jul. 10, 2024.

(51) Int. Cl. H04W 48/16

(52) U.S. Cl. CPC H04W 48/16

(57) ABSTRACT

An electronic device is described. This electronic device can include: an antenna node communicatively coupled to an antenna; and an interface circuit, communicatively coupled to the antenna node, that communicates with a second electronic device. During operation, the interface circuit can provide, addressed to at least the second electronic device, a query frame, where the query frame requests information about one or more access points in a neighborhood in a network. Then, the interface circuit can receive, associated with the second electronic device, a response frame based at least in part on the query frame, where the response frame includes second information about the one or more second access points in the neighborhood in the network.

### CROSS-REFERENCE TO RELATED APPLICATION

This application claims the benefit of U.S. Provisional Application No. 63/669,292, entitled “Communication of Query Management-Frame Content,” filed Jul. 10, 2024, the contents of which are hereby incorporated by reference.

### FIELD

The described embodiments relate, generally, to wireless communication among electronic devices, including the communication of query management frame content for improved access-point discovery.

### BACKGROUND

Many electronic devices communicate with each other using wireless local area networks (WLANs), such as those based on a communication protocol that is compatible with an Institute of Electrical and Electronics Engineers (IEEE) 802.11 standard (which is sometimes referred to as ‘Wi-Fi’).

In Wi-Fi communication, after association, access point(s) can be discovered using active or passive over-the-air (OTA) scanning. However, such scanning is often time-consuming. Moreover, for active scanning, there is also additional management frame overhead. These complications can be exacerbated when: an access-point multi-link device (MLD) is in proximity, because multiple collocated access points can be included in a given access-point MLD; and/or when there are multiple non-collocated access points in proximity.

### SUMMARY

Embodiments of an electronic device are described. This electronic device can include: an antenna node communicatively coupled to an antenna; and an interface circuit, communicatively coupled to the antenna node, that communicates with a second electronic device. During operation, the interface circuit provides, addressed to at least the second electronic device, a query frame, where the query frame requests information about one or more access points in a neighborhood in a network. Then, the interface circuit receives, associated with the second electronic device, a response frame based at least in part on the query frame, where the response frame includes second information about the one or more second access points in the neighborhood in the network.

Note that the electronic device can verify and/or update a roaming list of access points based at least in part on the second information.

Moreover, the information can be associated with a scan performed by the electronic device, and the electronic device can be associated with the second electronic device.

Furthermore, the neighborhood can be specified in the query frame by: a basic service set identifier (BSSID) of an anchor access point; an access-point MLD identifier of the anchor access point; a multi-link mobility domain (MLMD) identifier of the anchor access point; a band of frequencies; an operating class; a channel; or a basic service set (BSS) color. For example, the band of frequencies and/or the channel can be different from the band of frequencies and/or the channel used to communicate the query frame. Alternatively or additionally, the one or more second access points may not be collocated with the anchor access point.

Additionally, the one or more second access points can be specified by one or more corresponding criteria in the query frame. For example, the one or more criteria can include: a quality-of-service (QOS) metric; or a received signal strength indication (RSSI) criterion. Alternatively or additionally, the QoS metric can include: a throughput; a latency or a delay performance metric; and/or a BSS load.

In some embodiments, the one or more second access points can be associated with a different band of frequencies or a different network than the electronic device or the second electronic device.

Note that the second electronic device can include an access-point MLD.

Moreover, the second information can be, at least in part, different from the information.

Furthermore, the one or more second access points can be, at least in part, different from the one or more access points.

Additionally, the one or more access points can be fewer than available access points in the neighborhood.

In some embodiments, the one or more second access points can match or can be compatible with the information.

Other embodiments describe the second electronic device that performs counterpart operations to at least some of the operations performed by the electronic device. For example, the second electronic device can include: an antenna node communicatively coupled to an antenna; and an interface circuit, communicatively coupled to the antenna node, that communicates with the electronic device. During operation, the interface circuit receives, associated with the electronic device, a query frame, where the query frame requests information about one or more access points in a neighborhood in a network. Then, the interface circuit provides, addressed to at least the electronic device, a response frame based at least in part on the query frame, where the response frame includes second information about the one or more second access points in the neighborhood in the network.

Other embodiments describe integrated circuits (such as the interface circuit) for use with the electronic device or the second electronic device. The integrated circuits can perform at least some of the aforementioned operations of the electronic device or the second electronic device.

Other embodiments describe computer-readable storage medium for use with the electronic device and/or the second electronic device. When program instructions stored in the computer-readable storage medium are executed by the electronic device or the second electronic device, the program instructions can cause the electronic device or the second electronic device to perform at least some of the aforementioned operations of the electronic device or the second electronic device.

Other embodiments describe methods. The methods include at least some of the aforementioned operations performed by the electronic device or the second electronic device.

This Summary is provided for purposes of illustrating some exemplary embodiments, so as to provide a basic understanding of some aspects of the subject matter described herein. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The included drawings are for illustrative purposes and serve only to provide examples of possible structures and arrangements for the disclosed systems and techniques for intelligently and efficiently managing communication between multiple associated user devices. These drawings in no way limit any changes in form and detail that can be made to the embodiments by one skilled in the art without departing from the spirit and scope of the embodiments. The embodiments will be readily understood by the following detailed description in conjunction with the accompanying drawings, where like reference numerals designate like structural elements.

FIG. 1 is a block diagram illustrating an example of communication between electronic devices.

FIG. 2 is a block diagram illustrating an example of communication between electronic devices.

FIG. 3 is a flow diagram illustrating an example method for receiving a response frame using an electronic device of FIG. 1 or 2.

FIG. 4 is a flow diagram illustrating an example method for providing a response frame using an electronic device of FIG. 1 or 2.

FIGS. 5-7 are drawings illustrating examples of communication between the electronic devices of FIG. 1 or 2.

FIG. 8 is a drawing illustrating an example of a channel query parameters element.

FIGS. 9-12 are drawings illustrating examples of communication between the electronic devices of FIG. 1 or 2.

FIG. 13 illustrates an example of an electronic device of FIG. 1 according to some embodiments of the disclosure.

Note that like reference numerals refer to corresponding parts throughout the drawings. Moreover, multiple instances of the same part are designated by a common prefix separated from an instance number by a dash.

### DETAILED DESCRIPTION

An electronic device is described. This electronic device can include: an antenna node communicatively coupled to an antenna; and an interface circuit, communicatively coupled to the antenna node, that communicates with a second electronic device. During operation, the interface circuit can provide, addressed to at least the second electronic device, a query frame, where the query frame requests information about one or more access points in a neighborhood in a network. Then, the interface circuit can receive, associated with the second electronic device, a response frame based at least in part on the query frame, where the response frame includes second information about the one or more second access points in the neighborhood in the network.

By communicating the information and the second information, these communication techniques can improve discovery of the one or more second access points in the neighborhood in the network. Notably, these capabilities can simplify the discovery of neighboring access points by the electronic device. For example, the communication techniques can reduce the duration of a passive or active OTA scan that is performed by the electronic device. For active scans, the communication techniques can also reduce the management overhead in a network. In these ways, the communication techniques can improve the user experience when using the electronic device and/or the second electronic device.

In the discussion that follows, a user can include: an individual, an organization, a company, a governmental agency, a for-profit business entity, a not-for-profit entity, or a group of one or more individuals.

Note that the communication techniques can be used during or with wired or wireless communication between electronic devices in accordance with a communication protocol, such as a communication protocol that is compatible with an IEEE 802.11 standard (which is sometimes referred to as Wi-Fi). However, the communication techniques can also be used with a wide variety of other communication protocols, and in electronic devices (such as portable electronic devices or mobile devices) that can incorporate multiple different radio access technologies (RATs) to provide connections through different wireless networks that offer different services and/or capabilities.

The electronic device and/or the second electronic device can include hardware and software to support a wireless personal area network (WPAN) according to a WPAN communication protocol, such as those standardized by the Bluetooth Special Interest Group and/or those developed by Apple (in Cupertino, California) that are referred to as an Apple Wireless Direct Link (AWDL). Moreover, the electronic device and/or the second electronic device can communicate via: a wireless wide area network (WWAN), a wireless metro area network (WMAN), a WLAN, near-field communication (NFC), a cellular-telephone or data network (such as using a third generation (3G) communication protocol, a fourth generation (4G) communication protocol, e.g., Long Term Evolution or LTE, LTE Advanced (LTE-A), a fifth generation (5G) communication protocol, or other present or future developed advanced cellular communication protocol) and/or another communication protocol. In some embodiments, the communication protocol includes a peer-to-peer communication technique.

The electronic device and/or the second electronic device, in some embodiments, can also operate as part of a wireless communication system, which can include a set of client devices, which can also be referred to as stations or client electronic devices, interconnected to an access point, e.g., as part of a WLAN, and/or to each other, e.g., as part of a WPAN and/or an ‘ad hoc’ wireless network, such as a Wi-Fi direct connection. In some embodiments, the client device can be any electronic device that is capable of communicating via a WLAN technology, e.g., in accordance with a WLAN communication protocol. Furthermore, in some embodiments, the WLAN technology can include a Wi-Fi (or more generically a WLAN) wireless communication subsystem or radio, and the Wi-Fi radio can implement an IEEE 802.11 technology, such as one or more of: IEEE 802.11a; IEEE 802.11b; IEEE 802.11g; IEEE 802.11-2007; IEEE 802.11n; IEEE 802.11-2012; IEEE 802.11-2016; IEEE 802.11ac; IEEE 802.11ax, IEEE 802.11ba, IEEE 802.11be, IEEE 802.11me, IEEE 802.11bn, IEEE 802.11bx, IEEE 802.11mf or other present or future developed IEEE 802.11 technologies.

Note that the electronic device and/or the second electronic device can use multi-user transmission (such as OFDMA) and/or multiple-input multiple-output (MIMO).

In some embodiments, the electronic device and/or the second electronic device can act as a communications hub that provides access to a WLAN and/or to a WWAN and, thus, to a wide variety of services that can be supported by various applications executing on the electronic device and/or the second electronic device. Thus, the electronic device and/or the second electronic device can include an ‘access point’ that communicates wirelessly with other electronic devices (such as using Wi-Fi), and that provides access to another network (such as the Internet) via IEEE 802.3 (which is sometimes referred to as ‘Ethernet’). Note that the access point can be a physical access point or a virtual or ‘software’ access point that is implemented on a computer or an electronic device. However, in other embodiments the electronic device and/or the second electronic device may not be an access point.

Additionally, it should be understood that the electronic devices described herein can be configured as multi-mode wireless communication devices that are also capable of communicating via different 3G and/or second generation (2G) RATs. In these scenarios, a multi-mode electronic device or UE can be configured to prefer attachment to LTE networks offering faster data rate throughput, as compared to other 3G legacy networks offering lower data rate throughputs. For example, in some implementations, a multi-mode electronic device is configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable. More generally, the electronic devices described herein can be capable of communicating with other present or future developed cellular-telephone technologies.

In accordance with various embodiments described herein, the terms ‘wireless communication device,’ ‘electronic device,’ ‘mobile device,’ ‘mobile station,’ ‘wireless station,’ ‘wireless access point,’ ‘station,’ ‘access point’ and ‘user equipment’ (UE) can be used herein to describe one or more consumer electronic devices that can be capable of performing procedures associated with various embodiments of the disclosure.

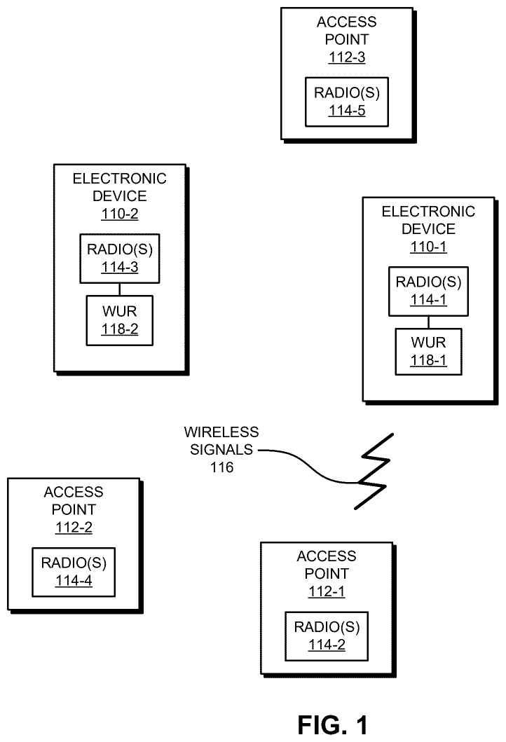

FIG. 1 presents a block diagram illustrating an example of electronic devices communicating wirelessly. Notably, one or more electronic devices 110 (such as a smartphone, a laptop computer, a notebook computer, a tablet, or another such electronic device) and access point 112-1 can communicate wirelessly in a WLAN using an IEEE 802.11 communication protocol. Thus, electronic devices 110 can be associated with, or can have one or more connections with, access point 112-1. For example, electronic devices 110 and access point 112-1 can wirelessly communicate while: detecting one another by scanning wireless channels, transmitting and receiving beacons or beacon frames on wireless channels, establishing connections (for example, by transmitting connect requests), and/or transmitting and receiving packets or frames (which can include the request and/or additional information, such as data, as payloads). Note that access point 112-1 can provide access to a network, such as the Internet, via an Ethernet protocol, and can be a physical access point or a virtual or ‘software’ access point that is implemented on a computer or other such electronic device. In the discussion that follows, electronic devices 110 are sometimes referred to as ‘clients,’ ‘stations,’ or ‘recipient electronic devices.’

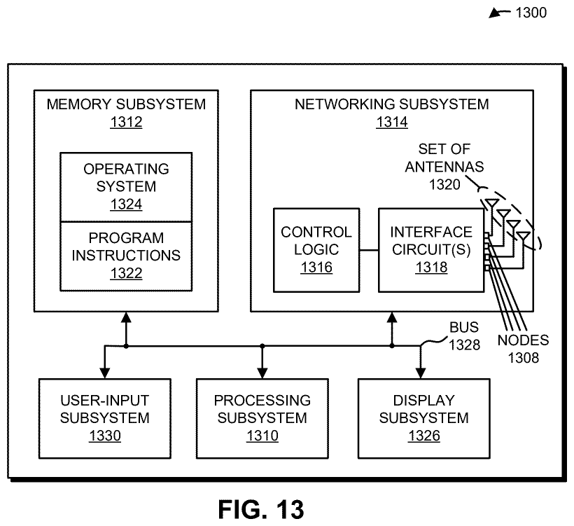

As described further below with reference to FIG. 13, electronic devices 110 and access point 112-1 can include subsystems, such as a networking subsystem, a memory subsystem, and a processor subsystem. In addition, electronic devices 110 and access point 112-1 can include radios 114 in the networking subsystems. More generally, electronic devices 110 and access point 112-1 can include (or can be included within) any electronic devices with networking subsystems that enable electronic devices 110 and access point 112-1, respectively, to wirelessly communicate with another electronic device. This can include transmitting beacon frames on wireless channels to enable the electronic devices to make initial contact with or to detect each other, followed by exchanging subsequent data/management frames (such as connect requests) to establish a connection, configure security options (e.g., IPSec), transmit and receive packets or frames via the connection, etc.

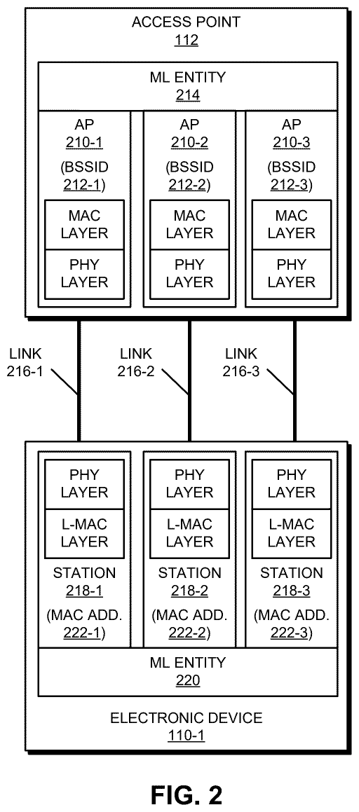

As can be seen in FIG. 1, wireless signals 116 (represented by a jagged line) are communicated by one or more radios 114-1 and 114-2 in electronic device 110-1 and access point 112-1, respectively. For example, as noted previously, electronic device 110-1 and access point 112-1 can exchange packets or frames using a Wi-Fi communication protocol in a WLAN. As illustrated further below with reference to FIGS. 2-12, one or more radios 114-1 can receive wireless signals 116 that are transmitted by one or more radios 114-2 via one or more links between electronic device 110-1 and access point 112-1. Alternatively, the one or more radios 114-1 can transmit wireless signals 116 that are received by the one or more radios 114-2.

In some embodiments, wireless signals 116 are communicated by one or more radios 114 in electronic devices 110 and access point 112-1, respectively. For example, one or more radios 114-1 and 114-3 can receive wireless signals 116 that are transmitted by one or more radios 114-2 via one or more links between electronic devices 110-1 and 110-2, and access point 112-1.

Note that the one or more radios 114-1 can consume additional power in a higher-power mode. If the one or more radios 114-1 remain in the higher-power mode even when they are not transmitting or receiving packets or frames, the power consumption of electronic device 110-1 can be needlessly increased. Consequently, electronic devices 110 can include wake-up radios (WURs) 118 that listen for and/or receive wake-up frames (and/or other wake-up communications), e.g., from access point 112-1. When a particular electronic device (such as electronic device 110-1) receives a wake-up frame, WUR 118-1 can selectively wake-up radio 114-1, e.g., by providing a wake-up signal that selectively transitions at least one of the one or more radios 114-1 from a lower-power mode to the higher-power mode.

IEEE 802.11be has proposed the use of multiple concurrent links between electronic devices, such as access point 112-1 and one or more of electronic device 110. For example, as shown in FIG. 2, which presents a block diagram illustrating an example of electronic devices communicating wirelessly, access point 112-1 can be an access point multi-link device (MLD) that includes multiple access points 210, which are cohosted or collocated in access point 112-1. In the present discussion, ‘cohosted’ or ‘collocated’ means that access points 210 are physically or virtually implemented in the same access point MLD, or are affiliated with the same access point MLD. Note that this meaning of ‘cohosted’ does not require that access points 210 have the same primary 20 MHz channel. Access points 210 can have associated BSSIDs 212, and media access control (MAC) and physical (PHY) layers (including separate radios, which can be included in the same or different integrated circuits). Note that access point 112-1 can have an ML entity 214 having an MLD MAC address, an ML identifier, a service set identifier (SSID), and that can provide security for access points 210.

Moreover, access points 210 can have different concurrent links 216 in different bands of frequencies (such as a link 216-1 with a link identifier 1 in a 2.4 GHz band of frequencies, a link 216-2 with a link identifier 2 in a 5 GHz band of frequencies and a link 216-3 with a link identifier 3 in a 6 GHz bands of frequencies) with stations 218 in at least electronic device 110-1, which is a non-access point MLD. These stations can have associated lower MAC and PHY layers (including separate radios, which can be included in the same or different integrated circuits). In addition, electronic device 110-1 can have an ML entity 220 having an MLD MAC address.

For example, the access point MLD can have three radios. One radio can operate on a 2.4 GHz band of frequencies, and the other radios can operate on the 5/6 GHz bands of frequencies. The access point MLD can create three access points 210, operating on a 2.4 GHz channel, a 5 GHz channel, and a 6 GHz channel respectively. The three access points 210 can operate independently, each of which has at least one BSS with different BSSIDs 212. (While FIG. 2 illustrates the access point MLD with three access points 210, more generally the access point MLD can include up to 15 access points with one or more access points in a given band of frequencies.) Moreover, each of the access points 210 can accommodate both legacy non-access point stations as well as non-access point MLD stations 218. Furthermore, each of access points 210 can transmit its own beacon frames using its own BSSID. Additionally, the access point MLD can have ML entity 214, identified by an MLD address (such as an MLD MAC address). This MAC address can be used to pair with ML entity 220 of the associated non-access point MLD stations 218.

Moreover, the non-access point MLD station (e.g., electronic device 110-1) can have two or three radios. One radio can operate on a 2.4 GHz band of frequencies, and the other radios can operate on the 5/6 GHz bands of frequencies. When the non-access point MLD establishes an ML association with the access point MLD, it can create up to three stations 218, each of which associates to one of access points 210 within the access point MLD. Each of stations 218 can have a different OTA MAC address 222. The non-access point MLD can also have ML entity 220, identified by another MLD address (such as another MLD MAC address). This MLD MAC address can be used to pair with ML entity 214 of the associated access point MLD.

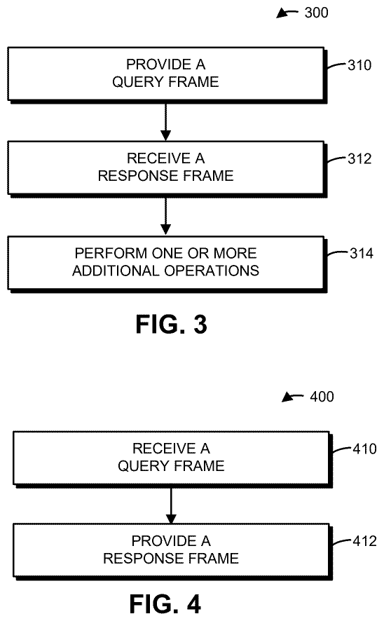

Referring back to FIG. 1, discovery of proximate access points can be complicated and time-consuming, and can increase management overhead in a network, especially when there are multiple neighboring access points. In order to address these problems, as described further below with reference to FIGS. 3-12, access point 112-1 and/or electronic device 110-1 can perform the communication techniques.

Notably, electronic device 110-1 can provide, addressed to at least access point 112-1, a query frame, where the query frame requests information about one or more of access points in a neighborhood in a network, such as access points 112-2 and 112-3. This query frame can be received by access point 112-1. Access point 112-1 can provide, addressed to at least electronic device 110-1, a response frame based at least in part on the query frame, where the response frame includes second information about one or more second access points (such as access point 112-2) in the neighborhood in the network. Electronic device 110-1 can receive, associated with access point 112-1, the response frame

Note that electronic device 110-1 can verify or update a roaming list of access points based at least in part on the second information.

Moreover, the information can be associated with a scan performed by electronic device 110-1, and electronic device 110-1 can be associated with access point 112-1.

Furthermore, the neighborhood can be specified in the query frame by: a BSSID of an anchor access point (such as access point 112-1); an access point MLD identifier of the anchor access point; a MLMD identifier of the anchor access point; a band of frequencies; an operating class; a channel; or a BSS color. For example, the band of frequencies and/or the channel can be different from the band of frequencies and/or the channel used to communicate the query frame. Alternatively or additionally, the one or more second access points may not be collocated with the anchor access point.

Additionally, the one or more second access points can be specified by one or more corresponding criteria in the query frame. For example, the one or more criteria can include a QoS metric or an RSSI criterion. Alternatively or additionally, the QoS metric can include a throughput, a latency or delay performance, and/or a BSS load.

In some embodiments, the one or more second access points can be associated with a different band of frequencies or a different network than electronic device 110-1 or access point 112-1.

Note that access point 112-1 can include an access-point MLD.

Moreover, the second information can be, at least in part, different from the information. Furthermore, the one or more second access points can be, at least in part, different from the one or more access points. Additionally, the one or more access points can be fewer than available access points in the neighborhood.

In some embodiments, the one or more second access points can match or can be compatible with the information.

The disclosed communication techniques can facilitate improved discovery of one or more of access points 112. For example, the communication techniques can reduce the duration of a passive or active OTA scan that is performed by electronic device 110-1. For active scans, the communication techniques can also reduce the management overhead in a network. In at least these ways, the communication techniques can improve the user experience when using electronic device 110-1 and/or access point 112-1.

While the preceding discussion illustrated communication by electronic device 110-1 to access point 112-1, in other embodiments the roles of access point 112-1 and electronic device 110-1 can be reversed in the communication techniques. For example, electronic device 110-1 can include a second access point and access point 112-1 can be a second electronic device that is a station or client that is associated with the second access point. Alternatively, in some embodiments, the communication techniques are performed between electronic device 110-1 and electronic device 110-2.

Note that access point 112-1 and one or more electronic devices (such as electronic devices 110-1 and/or 110-2) can be compatible with an IEEE 802.11 standard that includes trigger-based channel access (such as IEEE 802.11ax). However, access point 112-1 and the one or more electronic devices can also communicate with one or more legacy electronic devices that are not compatible with the same IEEE 802.11 standard (e.g., that do not use multi-user trigger-based channel access). In some embodiments, access point 112-1 and the one or more electronic devices can use multi-user transmission. For example, the one or more radios 114-2 can provide one or more trigger frames for the one or more electronic devices. Moreover, in response to receiving the one or more trigger frames, the one or more radios 114-1 can provide one or more group or block acknowledgments to the one or more radios 114-2. For example, the one or more radios 114-1 can provide the one or more group acknowledgments during associated assigned time slot(s) and/or in an assigned channel(s) in the one or more group acknowledgments. However, in some embodiments one or more of electronic devices 110 can individually provide acknowledgments to the one or more radios 114-2. Thus, the one or more radios 114-1 (and, more generally, radios 114 in the electronic devices 110-1 and/or 110-2) can provide one or more acknowledgments to the one or more radios 114-2.

In the described embodiments, processing a packet or frame in one of electronic devices 110 and access point 112-1 includes: receiving wireless signals 116 encoding a packet or a frame; decoding/extracting the packet or frame from received wireless signals 116 to acquire the packet or frame; and processing the packet or frame to determine information contained in the packet or frame (such as data in the payload).

In general, the communication via the WLAN in the communication techniques can be characterized by a variety of communication-performance metrics. For example, communication-performance metrics can include one or more of: an RSSI, a data rate, a data rate for successful communication (which is sometimes referred to as a ‘throughput’), a latency, an error rate (such as a retry or resend rate, or a negative acknowledgement rate), a mean-square error of equalized signals relative to an equalization target, inter-symbol interference, multipath interference, a signal-to-noise ratio (SNR), a width of an eye pattern, a ratio of a number of bytes successfully communicated during a predetermined or predefined time interval (such as a time interval between, e.g., 1 and 10 s) to an estimated maximum number of bytes that can be communicated in the predetermined or predefined time interval (the latter of which is sometimes referred to as the ‘capacity’ of a communication channel or link), and/or a ratio of an actual data rate to an estimated data rate (which is sometimes referred to as ‘utilization’).

Although we describe the network environment shown in FIG. 1 as an example, in alternative embodiments, different numbers and/or types of electronic devices can be present. For example, some embodiments can include more or fewer electronic devices. As another example, in other embodiments, different electronic devices can be transmitting and/or receiving packets or frames. In some embodiments, multiple links can be used during communication between electronic devices 110. Consequently, one of electronic devices 110 can perform operations in the communication techniques.

FIG. 3 presents a flow diagram illustrating an example method 300 for receiving a response frame. This method can be performed by an electronic device, such as electronic device 110-1 in FIG. 1. For example, method 300 can be implemented by an interface circuit in electronic device 110-1 in FIG. 1, which can be a station or client that is associated with access point 112-1. Note that the communication between the electronic device and a second electronic device (such as access point 112-1 in FIG. 1) can be compatible with an IEEE 802.11 communication protocol.

During operation, the electronic device can provide, addressed to at least the second electronic device, a query frame (operation 310), where the query frame requests information about one or more access points in a neighborhood in a network. Then, the electronic device can receive, associated with the second electronic device, a response frame (operation 312) based at least in part on the query frame, where the response frame includes second information about the one or more second access points in the neighborhood in the network.

Moreover, the information can be associated with a scan performed by the electronic device, and the electronic device can be associated with the second electronic device.

Furthermore, the neighborhood can be specified in the query frame, e.g., by any of a BSSID of an anchor access point, an access-point MLD identifier of the anchor access point, a MLMD identifier of the anchor access point, a band of frequencies, an operating class, a channel, or a basic service set (BSS) color. For example, the band of frequencies and/or the channel can be different from the band of frequencies and/or the channel used to communicate the query frame. Alternatively or additionally, the one or more second access points may not be collocated with the anchor access point.

Additionally, the one or more second access points can be specified by one or more corresponding criteria in the query frame. For example, the one or more criteria can include: a QoS metric; or an RSSI criterion. Alternatively or additionally, the QoS metric can include: a throughput; a latency or a delay performance metric; and/or a BSS load.

In some embodiments, the one or more second access points can be associated with a different band of frequencies or a different network than the electronic device or the second electronic device.

Note that the second electronic device can include an access-point MLD.

Moreover, the second information can be, at least in part, different from the information. Furthermore, the one or more second access points can be, at least in part, different from the one or more access points. Additionally, the one or more access points can be fewer than available access points in the neighborhood.

In some embodiments, the one or more second access points can match or can be compatible with the information.

In some embodiments, the electronic device can optionally perform one or more additional operations (operation 314). For example, the electronic device can verify or update a roaming list of access points based at least in part on the second information.

FIG. 4 presents a flow diagram illustrating an example method 400 for providing a response frame. This method can be performed by a second electronic device, such as access point 112-1 in FIG. 1. For example, method 300 can be implemented by an interface circuit in access point 112-1 in FIG. 1. Note that the communication between the second electronic device and an electronic device (such as electronic device 110-1 in FIG. 1, which can be a station or client that is associated with access point 112-1) can be compatible with an IEEE 802.11 communication protocol.

During operation, the second electronic device can receive, associated with the electronic device, a query frame (operation 410), where the query frame requests information about one or more access points in a neighborhood in a network. The second electronic device can provide, addressed to at least the electronic device, a response frame (operation 412) based at least in part on the query frame, where the response frame includes second information about the one or more second access points in the neighborhood in the network.

In some embodiments of methods 300 (FIG. 3) and/or 400, there can be additional or fewer operations. Further, one or more different operations can be included. Moreover, the order of the operations can be changed, and/or two or more operations can be combined into a single operation or performed at least partially in parallel.

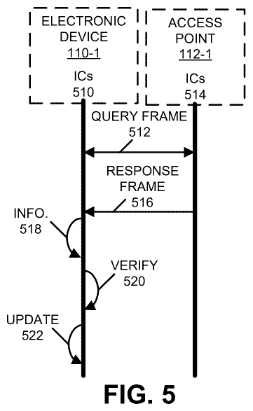

The communication techniques are further illustrated in FIG. 5, which presents a flow diagram illustrating an example of communication between electronic device 110-1 and access point 112-1. During operation, one or more interface circuits (or interface circuitry) 510 in electronic device 110-1 can provide, addressed to at least access point 112-1, a query frame 512, where the query frame requests information about one or more access points in a neighborhood in a network. This query frame can be received by one or more interface circuits (or interface circuitry) 514 in access point 112-1.

The one or more interface circuit 514 can provide, addressed to at least electronic device 110-1, a response frame 516 based at least in part on query frame 514, where response frame 516 includes information 518 about the one or more second access points in the neighborhood in the network. This response frame 516 can be received by the one or more interface circuits 510.

In some embodiments, after extracting information 518, the one or more interface circuits 510 can verify 520 a list of access points based at least in part on information 518. Alternatively or additionally, the one or more interface circuits 510 can update 522 a roaming list of access points based at least in part on information 518.

While communication between the components in FIG. 5 is illustrated with unilateral or bilateral communication (e.g., lines having a single arrow or dual arrows), in general a given communication operation can be unilateral or bilateral. Moreover, while operations in FIG. 5 are illustrated as being sequential, in some embodiments at least some of the operations can be performed in parallel.

We now further describe embodiments of the disclosed communication techniques. As discussed previously, access-point discovery using active or passive OTA scanning can be time-consuming and complicated, and can increase the management frame overhead in a network. These challenges can be addressed using the disclosed communication techniques.

Notably, starting in IEEE 802.11bn, a serving access point (such as a currently associated access-point MLD) can assist an associated station in the discovery of one or more roaming candidate access points, such as non-collocated access-point MLDs. For example, the discovery through a serving access point can be based at least in part on a neighbor access-point information query frame and a neighbor access-point information response frame signaling, e.g., between a non-access-point station and the serving access point. In response to receiving a neighbor access-point information query frame from a station, the serving access point can conduct an OTA or over-the-distribution system (OT-DS) message exchange with one or more non-collocated access-point MLDs. After receiving response(s) from the one or more non-collocated access point MLDs, the serving access point can provide the neighbor access-point information response frame to the station.

Moreover, a query and an associated response can be used to verify scanning results. For example, a query and an associated response can be used to request information about another access-point MLD and, more generally, access points in another neighborhood of another access-point MLD than a serving access-point MLD. More generally, this response signaling can be used to scan other networks through the serving access point. The query-frame details can be specified using one or more parameters, such as band of frequencies, channel and/or BSS color identifiers associated with a channel-specific scan. Note that the query response can include detailed performance information, such as BSS load, delay statistics, etc. In some implementations, the amount of content in the response frame can be managed to reduce scanning overhead.

Prior to roaming, an OTA scan can be used for initial association. For example, a probe request, probe response and/or beacon transmit/receive can be used to discover or target one or more available access points for initial association. A station can form an initial association with a BSS. For example, a station can use the BSS to access the Internet or discover other access point(s). The other access point(s) discovery can be performed over a protected link. The station can verify the information of one or more access points discovered using OTA scanning.

Alternatively or additionally, the station can discover one or more roaming candidate access points. For example, a station can use the query and response to verify the performance/achievable QoS of one or more available BSSs. Note that prior scan information or the information about one or more available access points through the serving access point can be used or selected by the station.

Moreover, the station can roam or transition to a new BSS.

In some embodiments, after joining and association, the query and response can be used to facilitate discovery. When health of a link is acceptable, a station can associate with a current access point (e.g., via a four-way handshake). This can be a low-latency use case. The station can perform a one-time or periodic verification of scanning results using the query and response. Moreover, the station can perform ‘enhanced’ lazy roam operations, e.g., using query and response for access-point discovery in roaming. This can also facilitate rapid RSSI by the station and/or passive beacon reception. Furthermore, the station can create a roam cache list, such as a list of roaming candidate access points. This list can include: ‘N’ access points (where N is an integer) and stored information (such as a basic service set identifier or BSSID, a channel, a Target Beacon Transmission Time (TBTT), etc.). Note that query and response can be used for access-point load check (and, more generally, dynamic parameters). In some embodiments, query-response signaling can be performed periodically or after an operator-defined time interval (such as every 10 ms, 100 ms, 1 s, etc.).

When the health of the link is not acceptable, the station can commence pre-roaming operations. These operations can leverage roaming candidate access points that are already available when a roaming trigger is received. Notably, a station can perform rapid RSSI measurements with one or more roaming candidate access points. Alternatively or additionally, a station can ask a current access point for an early QoS assurance from one or more roaming candidate access points (thus, query and response can be used for access-point QoS verification). Roaming can be attempted to a favored access point of the roaming candidate access points (such as with access point(s) that have better communication performance relative to one or more other candidate access points).

Moreover, during access-point discovery for automatic joining in the query operations, a serving access point can provide one or more other BSSs parameters (such as the BSSs of other networks) through query-response signaling. The station can request collocated or neighbor access-point parameters. For example, an SSID or address can be used to identify the queried access point(s). The station can discover networks faster and/or with lower power consumption. The network operator can promote selected network discoverability.

Furthermore, in scanning results verification in the query operations, a station can detect access point(s) during scanning. The station can verify the information of the detected access point(s) and obtain one or more corresponding access-point parameters. The station can query the access-point information that is detected while scanning. The serving access point can verify the detected access point and its information. In some implementations, the station can verify that the access point is real and can obtain a complete set of access-point parameters and performance information.

Additionally, during access-point discovery for roaming in the query operations, a station can prepare for roaming. For example, the station can check its performance in the access point through the serving access point. In this way, the station can ensure its performance in the neighbor access-point MLD. Note that this can provide reduced OTA scanning of roaming candidate access point(s). The station can discover roaming candidate access points faster and/or with lower power consumption.

Note that, during roaming candidate access-point load and parameter check in the query operations, a station can maintain a roaming candidate list by checking whether the access point(s) in the list have resources available for a roaming station. The station can query the roaming candidate access point(s) based at least in part on their OTA link address or MLD address. The station can update BSS parameters. However, the RSSI may need to be separately maintained.

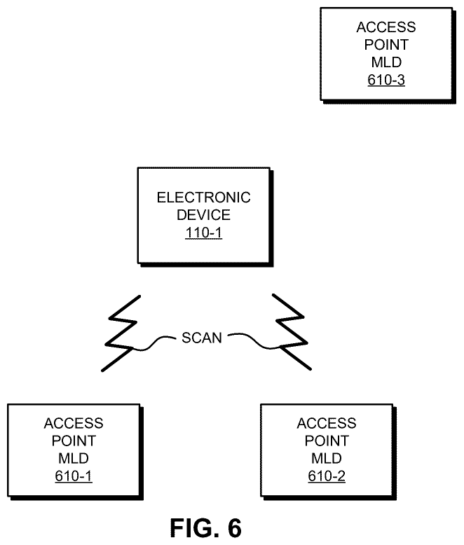

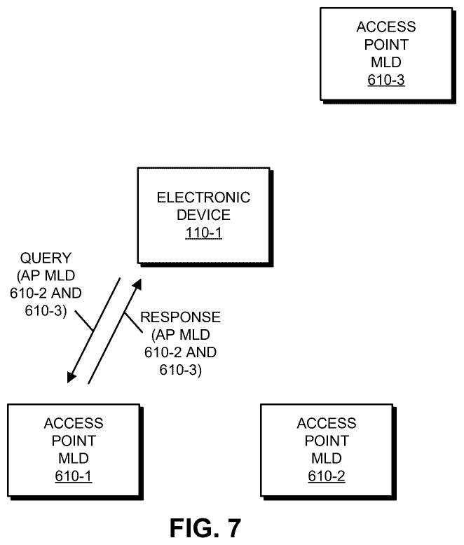

FIGS. 6 and 7 present drawings illustrating examples of communication between electronic device 110-1 and one or more of access points 610. As shown in FIGS. 6 and 7, a query can be used to verify scanning results. A station (such as electronic device 110-1) can scan available access points for auto join, e.g., initial association for Internet connectivity. The scanning can be targeted to discover if there are one or more access points (such as access point 610-2) in proximity with which the station can associate. Moreover, a station can discover OTA access-point MLDs, such as access-point MLDs 610-1 to 610-3. The access-point MLDs can be on the same network or another network. In some implementations, the station does not perform a complete scan, instead performing a fast partial scan. Furthermore, the station can associate with an access-point MLD, such as access-point MLD 610-1. The access-point MLD 610-1 performance may not satisfy all desired criteria. However, the access point can offer some throughput and network connectivity. Additionally, a station can verify one or more other access-point MLD parameters (such as access-point MLD 610-2 and 610-3 parameters) through serving access-point MLD 610-1. In some instances, the OTA parameters received can be from an attacker access point. The serving access point responses can verify that the one or more values received are not from such an attacking access point. One or more other access-point parameters can be verified using OT-DS (such as communication with a target access point via a current access point, e.g., using Ethernet communication) or OTA. Access points can have a common service discovery application to distribute and receive query and response messages. A network operator can manage multiple networks and access points. The network operator can offer signaling between networks or within the network. Access points can belong to the same wireless mesh network and have common mesh network-specific management. In some embodiments, the query-response signaling can be performed regularly (as opposed to waiting for the performance of a current link to degrade).

A query is different from a probe request and a basic service set transition management (BTM) query. For instance, a probe request is transmitted on the requested channel. Access points operating on the channel in which the probe request is transmitted can respond. A BTM query may need to specify the access point to which the station checks whether the access-point recommends the station to roam to the access point. The BTM query may need to specify the access point that is queried (including BSSID and other parameters). Partial information or just the access-point primary channel is not sufficient. In contrast, a query of the access point can be done using partial information. The query can be transmitted to the serving access point, so when the query requests access-point MLD information on a specific channel or band it usually needs to signal the channel and band information. Note that IEEE 802.11 standards do not currently specify element(s) to signal the queried band(s) of frequencies or channel(s). Moreover, note that some, multiple, or specific channel(s) or band(s) of frequencies can be queried with a single query.

Furthermore, in some embodiments BSS color can be used as an access-point query parameter. This can allow a neighborhood to be specified. Notably, a station can have a low-power receive radio that the station can use for scanning. Typically, the low-power receive radio (LRR) can only receive at a 20 MHz channel, one spatial stream and 24 Mbit/s or lower throughput. When an access point sends an ultra-high-reliability (UHR) or extremely high-throughput (EHT) transmission, the LRR can receive only preambles of the physical layer protocol data units (PPDUs), which are transmitted as 20 MHz duplicates and at low transmission rates. Currently, the station may not have a way to request access-point parameters by using the channel and BSS color. BSS color can be added as a query parameter to enable precise queries for the station. Alternatively, the station can query all access points in a channel, but in this approach, the station may get information for other access points when the channel has multiple BSSs.

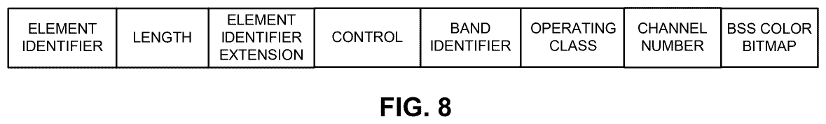

FIG. 8 presents a drawing illustrating an example of a channel query parameters element, which can include a band-of-frequencies or channel-specific access-point query. Notably, a channel query parameters element can provide a per-station profile and can include any/all of: an element identifier (e.g., one octet); a length (e.g., one octet); an element identifier extension (e.g., one octet); a control (e.g., one octet); a band identifier for a band that is of interest, such as 5 or 6 GHz (e.g., zero or one octet); an operating class (e.g., zero or one octet); a channel number (e.g., zero or one octet); one or more addresses (such as an anchor access-point BSSID list) and/or a BSS color bitmap (e.g., zero or eight octets). The size used to represent a parameter can be modified in other implementations, e.g., based on requirements and overall considerations. The channel query element can specify queried access-point color value(s), the queried channel, and/or the queried band of frequencies. Moreover, the channel query element can specify a query for a band identifier, an operating class, and/or a channel in the operating class. When the channel query element is not present, there may be no limitations on the queried bands of frequencies or channels. Note that the control field can define which fields are present in the channel query element. Band identifier can be defined in 9.4.1.43 (a band identifier field). This is general setting for the queried-band operating class and channel number can define the queried channel. When only the operating class field is present, then all channels in the operating class can be queried. Alternatively, when both operating class and channel are present, the specified channel can be queried. The BSS color can define the queried access-point MLD or access point. The BSS color can specify one or more neighboring access points that operate on the same channel. Thus, BSS color can facilitate coexistence. When two adjacent access points have the same BSS color, they can control their transmit powers to facilitate spectrum reuse. Note that when the channel or band of frequencies is included, the query can be made or performed on the specified channel. In some embodiments, the neighborhood can be specified using an RSSI criterion, such as within −75 or −80 dBm of an RSSI-anchor access point. In some embodiments, the discovery can be directional, such as a compass direction from an anchor access point on which the one or more access points are queried.

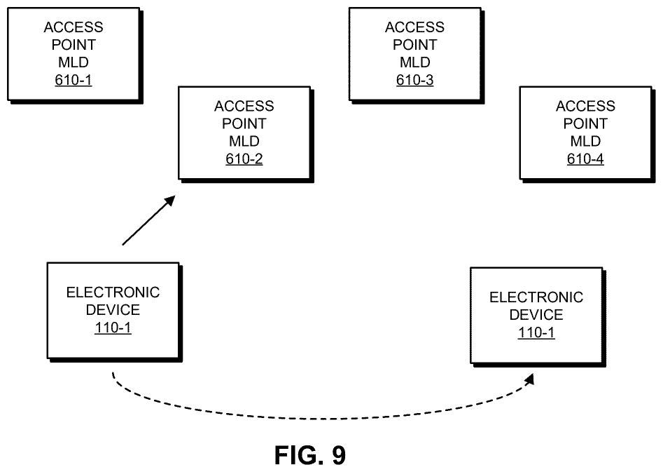

Additionally, a query can be used in roaming scanning. This is shown in FIG. 9, which presents a drawing illustrating an example of communication between electronic device 110-1 and access points 610. Notably, an associated station (such as electronic device 110-1) can need to roam to another access-point MLD. For example, when the station scanned and associated, the serving access-point MLD (such as access point 610-2) was the best alternative. However, the station may have moved and the link to the serving access point can be poorer. The access-point MLD 610-4 in proximity can have better roaming candidate access points.

The station may have detected one or more neighboring access point(s), or can know about the neighboring access point(s) from previous associations. The station can query access-point parameters by identifying the queried access point through BSSID or MLD address. The station can detect WLAN traffic on band(s) of frequencies or channel(s). The station can use band-of-frequency/channel information as a query criterion. Note that the station may not know whether access points are available. The station can query access points 610 in the same network by using an SSID. The station can query access points in the same MLMD by using an MLMD identifier. An MLMD can include a physical access point that hosts different access-point MLDs. An MLMD can include a virtual MLD in which access points are not collocated. Moreover, an MLMD can be a virtual device that includes different links in different bands of frequencies (as specified by a corresponding link identifier). For example, each physical access point can be included in various access-point MLDs. Note that the station can query all access-point parameters by not adding any identifier to the query. Thus, in some embodiments, the query can, directly or indirectly, be a wildcard or broadcast query.

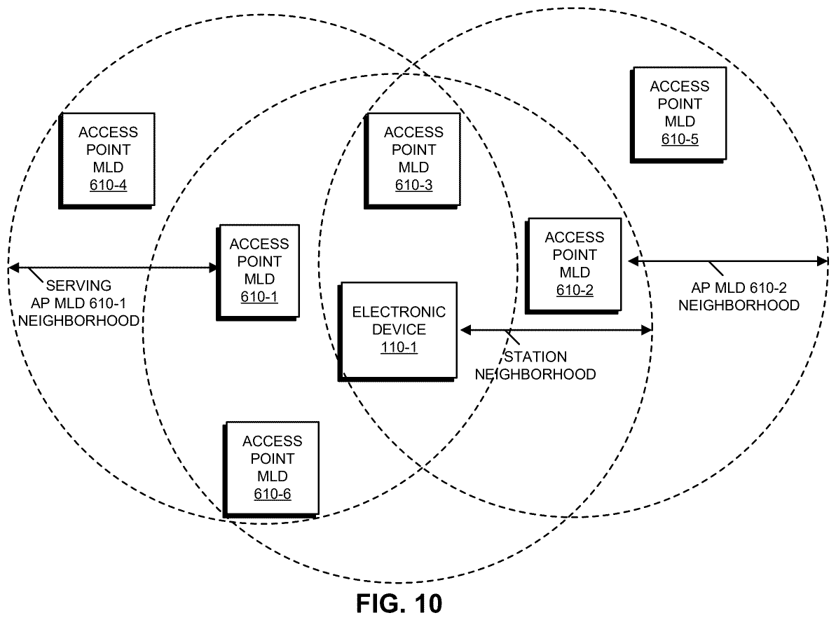

As shown in FIG. 10, which presents a drawing illustrating an example of communication between an electronic device 110 and access points 610, a query can be used for roaming discovery enhancements. Notably, the station link to the serving access point (such as access point 610-1) can be poor. The station (such as electronic device 110-1) may not have scanned all channels or all available access points in its new location. The station can request reporting of the access-point parameters around locations other than the serving access-point MLD. For example, the station can query collocated and neighbor access points around a selected access-point MLD (such as access point 610-1). The query and response frames can be transmitted through the serving access-point MLD.

Note that the access-point MLDs can have multiple alternatives to select which access points are neighbor access points. For example, when OTA transmissions or receptions are possibilities for a neighbor access-point MLD in any supported band of frequencies, an access-point MLD can be considered as the neighbor access point. The access-point MLD can measure the RSSI of the neighbor access point and consider the access point to be a neighbor when the RSSI is above a threshold. A network operator can configure the neighbor access point(s) based at least in part on access-point locations.

In some embodiments, the station neighborhood in the query can be different. For example, the serving access-point MLD neighborhood (such as the neighborhood of access point 610-1) and another access-point MLD neighborhood (such as the neighborhood of access point 610-2) can be different. When the station requests neighboring access points on the serving access-point MLD and the other access-point MLD, the set of provided access-point parameters can more likely contain an advantageous roaming candidate access-point MLD (e.g., an access point that offers improved performance relative to one or more other candidate access points).

Moreover, query parameters to solicit information can include: discovery criteria, element names, when a given element name is used for a type of discovery, where the element is currently located, and/or the use of the element. For example, an SSID can be included in an SSID list (of one or more SSIDs) and/or in a short SSID list (e.g., a four octet hash of SSIDs). The SSID can be used for automatic joining and/or verification. Currently, the SSID list or the short SSID list are included in a probe request body. When present in a query in the communication techniques, the SSID list or the short SSID list can specify a scanned network based at least in part on the SSID.

Furthermore, the band of frequencies and channel can include: a band identifier, an operating class, a channel number and/or a BSS color bitmap list. The band of frequencies and channel can be used for automatic joining (or auto join) and/or verification. These elements are currently not present and a probe request is currently transmitted on one channel. Thus, when present in a query in the communication techniques, the band of frequencies and the channel can specify the scanned channel.

Additionally, the address can include: a proximate access-point address, a BSSID list, a known BSSID list and/or an MLD address list. The proximate access-point address can be used for roaming, while the other parameters can be used for automatic joining, verification and/or roaming. The proximate access-point address is not present in existing approaches, and active and passive scanning can handle this information differently. When present in a query in the communication techniques, the proximate access-point address can allow a station to signal the area or neighborhood of the reported access points. The BSSID is included in the MAC header in existing approaches, but the BSSID is not available in the existing approaches. Moreover, when present in a query in the communication techniques, the BSSID list can specify the responding access points. Note that the known BSSID list is an element in a probe request body in existing approaches. When present in a query in the communication techniques, the known BSSID list can specify the access points that do not respond. The MLD address list is not present in existing approaches. Furthermore, when present in a query in the communication techniques, the MLD address can specify the responding access-point MLDs.

In some embodiments, a short identifier can include: an MLMD identifier bit map (or a Wi-Fi 8 access-point identifier); an MLD identifier bit map (or a Wi-Fi 7 access-point identifier); and/or a link identifier bitmap (or a Wi-Fi 6 access point). The short identifier can be used for verification and/or roaming. The MLMD identifier bitmap is not present in existing approaches, and the MLD identifier bitmap and the link identifier bitmap are included in a probe request variant multi-link element in existing approaches. When present in a query in the communication techniques, the short identifier can signal a short notation of the access point.

Note that a probe request multi-link element can be included in a multi-link control and/or common information. The multi-link control can include a bitmap for what information is included in the common information. K, the number of reported access points, can be a maximum of 255 when a bit in the probe request multi-link element is asserted. Moreover, a proximate access point can include an anchor access point that specifies a neighborhood. In response, the access point can report any matches for the access point(s) to be reported.

The query parameters can be used in a variety of ways. For example, in response to the presence of the band (of frequencies), operating class and/or channel number list in a query, access point(s) can provide information about all access points and access-point MLDs operating in the specified band of frequencies, operating class and/or channel number collocated or neighbors of the serving access point. Moreover, in response to the presence of an SSID or short SSID list in a query, access point(s) can provide information about access points and access-point MLDs with the specified SSID collocated or neighbors of the serving access point. Furthermore, in response to the presence of a BSSID or MLD address list and/or an MLMD identifier, an MLD identifier, and/or an access-point identifier or list in a query, access point(s) can provide information of all access points and access-point MLDs matching with the address(es) or identifier(s) and that are collocated or neighbors of the serving access point. Additionally, in response to the presence of a proximity address in a query, access point(s) can provide information about the collocated access points and neighboring access points of the proximity-address access point.

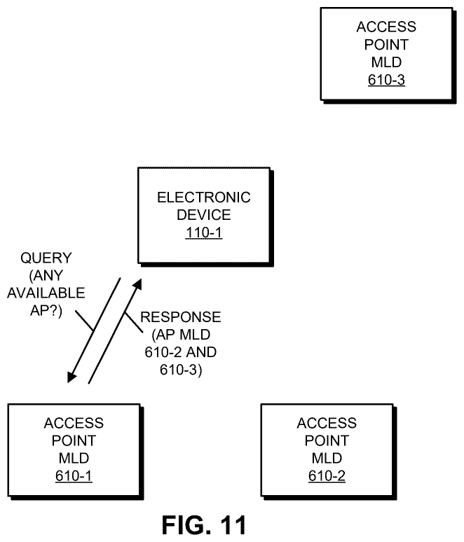

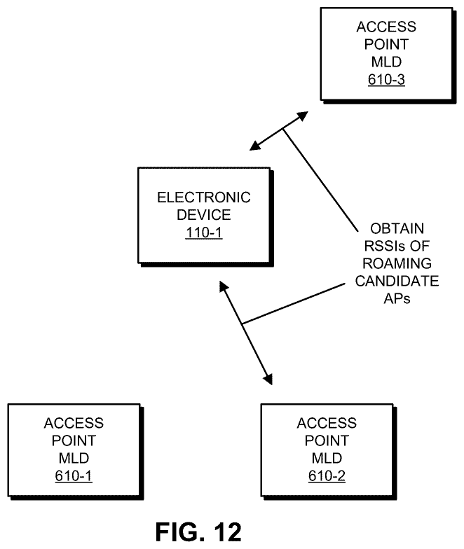

FIGS. 11 and 12 present drawings illustrating examples of communication between electronic device 110-1 and access points 610, which show the overhead reduction of response frames. Notably, dense network deployments can have a lot of neighboring access points. A query frame can request all neighboring and collocated access-point information. However, signaling all parameters of all access points can create very large response frames and can increase management-traffic overhead. The serving access point (such as access point 610-1) can limit the size of the response frames. For example, the serving access point can limit the number of access points for which a full set of parameters is reported. Moreover, the serving access point can report the number of access points that match the query and the number of access points for which information is listed in detail. The response frame can provide general information for access points responsive to a query (such as a number of access points, operating channels, etc.). The response frame can provide a reduced neighbor report (RNR) for the access points for which parameters are not listed in detail. A station (such as electronic device 110-1) can explicitly request parameters of all collocated access points or neighboring access points. For example, the station can send the exact same query frame. The query frame can have a ‘Next Access Point Reporting’ field to request reporting of the following access point(s). The complete listing of the available access points can help the station to report all available networks for the end user.

In general, a query can include a per-station profile. For example, the query can include response criterion, such as: a BSS load bit; and/or a QoS verification (such as a QoS attribute of interest or a stream classification service or SCS). Notably, the QoS verification can include: a throughput, a latency, a delay performance, etc. In the response, neighboring access point(s) can indicate when they meet the one or more criteria.

While a query can specify the information to include in a response, an access point (such as access point 610-2) can choose to include different information than what is specified in a query. For example, an access point can include BSS information that does not match the query. This override can be performed by the access point when a new BSS is available, when one or more parameters (such as a BSS load) have changed, etc.

In some embodiments, the communication techniques can be implemented in a physical layer and/or a MAC layer.

Note that the formats of packets or frames communicated during the communication techniques can include more or fewer bits, subfields, and/or fields. Alternatively or additionally, the position of information in these packets or frames can be changed. Thus, the order of the subfields and/or fields can be changed.

While the preceding embodiments illustrate embodiments of the communication techniques using frequency sub-bands, in other embodiments the communication techniques can involve the concurrent use of different temporal slots, and/or or a combination of different frequency sub-bands, different frequency bands and/or different temporal slots. In some embodiments, the communication techniques can use OFDMA.

Moreover, while the preceding embodiments illustrated the use of Wi-Fi during the communication techniques, in other embodiments of the communication techniques Bluetooth or Bluetooth Low Energy is used to communicate at least a portion of the information in the communication techniques. Furthermore, the information communicated in the communication techniques can be communicated or can occur in one or more frequency bands, including: 900 MHz, a 2.4 GHz frequency band, a 5 GHz frequency band, a 6 GHz frequency band, a 60 GHz frequency band, a Citizens Broadband Radio Service (CBRS) frequency band, a band of frequencies used by LTE or another data communication protocol, etc.

As described herein, aspects of the present technology can include the gathering and use of data available from various sources, e.g., to improve or enhance functionality. The present disclosure contemplates that in some instances, this gathered data can include personal information data that uniquely identifies or can be used to contact or locate a specific person. Such personal information data can include demographic data, location-based data, telephone numbers, email addresses, Twitter ID's, home addresses, data or records relating to a user's health or level of fitness (e.g., vital signs measurements, medication information, exercise information), date of birth, or any other identifying or personal information. The present disclosure recognizes that the use of such personal information data, in the present technology, can be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configurable to allow users to selectively “opt in” or “opt out” of participation in the collection of personal information data, e.g., during registration for services or anytime thereafter. In addition to providing “opt in” and “opt out” options, the present disclosure contemplates providing notifications relating to the access or use of personal information. For instance, a user can be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure can broadly cover use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 13 presents a block diagram of an electronic device 1300 (which can be a cellular telephone, a smartwatch, an access point, a wireless speaker, an IoT device, another electronic device, etc.) in accordance with some embodiments. This electronic device includes processing subsystem 1310, memory subsystem 1312 and networking subsystem 1314. Processing subsystem 1310 includes one or more devices configured to perform computational operations. For example, processing subsystem 1310 can include one or more microprocessors, application-specific integrated circuits (ASICs), microcontrollers, graphics processing units (GPUs), programmable-logic devices, and/or one or more digital signal processors (DSPs).

Memory subsystem 1312 includes one or more devices for storing data and/or instructions for processing subsystem 1310, and/or networking subsystem 1314. For example, memory subsystem 1312 can include dynamic random access memory (DRAM), static random access memory (SRAM), a read-only memory (ROM), flash memory, and/or other types of memory. In some embodiments, instructions for processing subsystem 1310 in memory subsystem 1312 include: program instructions or sets of instructions (such as program instructions 1322 or operating system 1324), which can be executed by processing subsystem 1310. For example, a ROM can store programs, utilities or processes to be executed in a non-volatile manner, and DRAM can provide volatile data storage, and can store instructions related to the operation of electronic device 1300. Note that the one or more computer programs can constitute a computer-program mechanism, a computer-readable storage medium or software. Moreover, instructions in the various modules in memory subsystem 1312 can be implemented in: a high-level procedural language, an object-oriented programming language, and/or in an assembly or machine language. Furthermore, the programming language can be compiled or interpreted, e.g., configurable or configured (which can be used interchangeably in this discussion), to be executed by processing subsystem 1310. In some embodiments, the one or more computer programs are distributed over a network-coupled computer system so that the one or more computer programs are stored and executed in a distributed manner.

In addition, memory subsystem 1312 can include mechanisms for controlling access to the memory. In some embodiments, memory subsystem 1312 includes a memory hierarchy that includes one or more caches coupled to a memory in electronic device 1300. In some of these embodiments, one or more of the caches is located in processing subsystem 1310.

In some embodiments, memory subsystem 1312 is coupled to one or more high-capacity mass-storage devices (not shown). For example, memory subsystem 1312 can be coupled to a magnetic or optical drive, a solid-state drive, or another type of mass-storage device. In these embodiments, memory subsystem 1312 can be used by electronic device 1300 as fast-access storage for often-used data, while the mass-storage device is used to store less frequently used data.

Networking subsystem 1314 includes one or more devices configured to couple to and communicate on a wired and/or wireless network (i.e., to perform network operations), such as: control logic 1316, one or more interface circuits (or interface circuitry) 1318 and a set of antennas 1320 (or antenna elements) in an adaptive array that can be selectively turned on and/or off by control logic 1316 to create a variety of optional antenna patterns or ‘beam patterns.’ Alternatively, instead of the set of antennas, in some embodiments electronic device 1300 includes one or more nodes 1308, e.g., a pad or a connector, which can be coupled to the set of antennas 1320. Thus, electronic device 1300 may or may not include the set of antennas 1320. For example, networking subsystem 1314 can include a Bluetooth™ networking system, a cellular networking system (e.g., a 3G/4G/5G network such as UMTS, LTE, etc.), a universal serial bus (USB) networking system, a networking system based on the standards described in IEEE 802.12 (e.g., a Wi-Fi® networking system), an Ethernet networking system, and/or another networking system.

In some embodiments, networking subsystem 1314 includes one or more radios, such as a wake-up radio that is used to receive wake-up frames and wake-up beacons, and a main radio that is used to transmit and/or receive frames or packets during a normal operation mode. The wake-up radio and the main radio can be implemented separately (such as using discrete components or separate integrated circuits) or in a common integrated circuit.

Networking subsystem 1314 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 1300 can use the mechanisms in networking subsystem 1314 for performing simple wireless communication between the electronic devices, e.g., transmitting advertising or frame frames and/or scanning for advertising frames transmitted by other electronic devices.

Within electronic device 1300, processing subsystem 1310, memory subsystem 1312 and networking subsystem 1314 are coupled together using bus 1328 that facilitates data transfer between these components. Bus 1328 can include an electrical, optical, and/or electro-optical connection that the subsystems can use to communicate commands and data among one another. Although only one bus 1328 is shown for clarity, different embodiments can include a different number or configuration of electrical, optical, and/or electro-optical connections among the subsystems.

In some embodiments, electronic device 1300 includes a display subsystem 1326 for displaying information on a display, which can include a display driver and the display, such as a liquid-crystal display, a multi-touch touchscreen, etc. Display subsystem 1326 can be controlled by processing subsystem 1310 to display information to a user (e.g., information relating to incoming, outgoing, or an active communication session).

Moreover, electronic device 1300 can also include a user-input subsystem 1330 that allows a user of the electronic device 1300 to interact with electronic device 1300. For example, user-input subsystem 1330 can take a variety of forms, such as: a button, keypad, dial, touch screen, audio input interface, visual/image capture input interface, input in the form of sensor data, etc.

Electronic device 1300 can be (or can be included in) any electronic device with at least one network interface. For example, electronic device 1300 can include: a cellular telephone or a smartphone, a tablet computer, a laptop computer, a notebook computer, a personal or desktop computer, a netbook computer, a media player device, a wireless speaker, an IoT device, an electronic book device, a MiFi® device, a smartwatch, a wearable computing device, a portable computing device, a consumer-electronic device, a vehicle, a door, a window, a portal, an access point, a router, a switch, communication equipment, test equipment, as well as any other type of electronic computing device having wireless communication capability that can include communication via one or more wireless communication protocols.

Although specific components are used to describe electronic device 1300, in alternative embodiments, different components and/or subsystems can be present in electronic device 1300. For example, electronic device 1300 can include one or more additional processing subsystems, memory subsystems, networking subsystems, and/or display subsystems. Additionally, one or more of the subsystems may not be present in electronic device 1300. Moreover, in some embodiments, electronic device 1300 can include one or more additional subsystems that are not shown in FIG. 13. In some embodiments, electronic device 1300 can include an analysis subsystem that performs at least some of the operations in the communication techniques. Also, although separate subsystems are shown in FIG. 13, in some embodiments some or all of a given subsystem or component can be integrated into one or more of the other subsystems or component(s) in electronic device 1300. For example, in some embodiments program instructions 1322 are included in operating system 1324 and/or control logic 1316 is included in the one or more interface circuits 1318.

Moreover, the circuits and components in electronic device 1300 can be implemented using any combination of analog and/or digital circuitry, including: bipolar, PMOS and/or NMOS gates or transistors. Furthermore, signals in these embodiments can include digital signals that have approximately discrete values and/or analog signals that have continuous values. Additionally, components and circuits can be single-ended or differential, and power supplies can be unipolar or bipolar.

An integrated circuit can implement some or all of the functionality of networking subsystem 1314. This integrated circuit can include hardware and/or software mechanisms that are used for transmitting wireless signals from electronic device 1300 and receiving signals at electronic device 1300 from other electronic devices. Aside from the mechanisms herein described, radios are generally known in the art and hence are not described in detail. In general, networking subsystem 1314 and/or the integrated circuit can include any number of radios. Note that the radios in multiple-radio embodiments function in a similar way to the described single-radio embodiments.

In some embodiments, networking subsystem 1314 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein includes receiving signals from other electronic devices and possibly performing one or more processing operations on the received signals).

In some embodiments, an output of a process for designing the integrated circuit, or a portion of the integrated circuit, which includes one or more of the circuits described herein can be a computer-readable medium such as, for example, a magnetic tape or an optical or magnetic disk. The computer-readable medium can be encoded with data structures or other information describing circuitry that can be physically instantiated as the integrated circuit or the portion of the integrated circuit. Although various formats can be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematic diagrams of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used a Wi-Fi communication protocol as an illustrative example, in other embodiments a wide variety of communication protocols and, more generally, wireless communication techniques can be used. Thus, the communication techniques can be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments can be performed in hardware, in software or both. For example, at least some of the operations in the communication techniques can be implemented using program instructions 1322, operating system 1324 (such as a driver for an interface circuit in networking subsystem 1314) or in firmware in an interface circuit networking subsystem 1314. Alternatively or additionally, at least some of the operations in the communication techniques can be implemented in a physical layer, such as hardware in an interface circuit or interface circuitry in networking subsystem 1314. In some embodiments, the communication techniques are implemented, at least in part, in a MAC layer and/or in a physical layer in an interface circuit in networking subsystem 1314.

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

Moreover, while the preceding embodiments illustrated the use of wireless signals in one or more bands of frequencies, in other embodiments of the communication techniques electromagnetic signals in one or more different frequency bands are used. For example, these signals can be communicated in one or more bands of frequencies, including: a microwave frequency band, a radar frequency band, 900 MHZ, 2.4 GHz, 5 GHZ, 6 GHz, 60 GHz, and/or a band of frequencies used by a Citizens Broadband Radio Service or by LTE.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein can be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an antenna node configured to communicatively couple to an antenna; and
an interface circuit, communicatively coupled to the antenna node, configured to process communications with a second electronic device, wherein the interface circuit is configured to:
generate, addressed to at least the second electronic device, a query frame that requests information corresponding to one or more access points in a network; and
receive a response frame, associated with the second electronic device, based at least in part on the query frame, wherein the response frame comprises second information corresponding to the one or more second access points in the network.

2. The electronic device of claim 1, wherein the electronic device is configured to verify or update a roaming list of access points based at least in part on the second information.

3. The electronic device of claim 1, wherein the information corresponds to a scan performed by the electronic device; and
wherein the electronic device is associated with the second electronic device.

4. The electronic device of claim 1, wherein a neighborhood in the network is specified in the query frame by at least one of: a basic service set identifier (BSSID) of an anchor access point; an access-point multi-link device (MLD) identifier of the anchor access point; a multi-link mobility domain (MLMD) identifier of the anchor access point; a band of frequencies; an operating class; a channel; or a basic service set (BSS) color.

5. The electronic device of claim 4, wherein the band of frequencies, the channel, or both are different from the band of frequencies, the channel, or both used to communicate the query frame.

6. The electronic device of claim 4, wherein the one or more second access points are not collocated with the anchor access point.

7. The electronic device of claim 1, wherein the one or more second access points are specified by one or more corresponding criteria of the query frame.

8. The electronic device of claim 7, wherein the one or more criteria comprise a quality-of-service (QOS) metric or a received signal strength indication (RSSI) criterion.

9. The electronic device of claim 8, wherein the QoS metric comprises: a throughput; a latency metric; a delay performance metric; or a basic service set (BSS) load.

10. The electronic device of claim 1, wherein the one or more second access points are associated with a different band of frequencies or a different network than the electronic device or the second electronic device.

11. The electronic device of claim 1, wherein the one or more second access points match or are otherwise compatible with the information.

12. A method for receiving a response, comprising:
by an electronic device:
generating, addressed to at least a second electronic device, a query frame that requests information corresponding to one or more access points in a network; and
receive the response frame, associated with the second electronic device, based at least in part on the query frame, wherein the response frame comprises second information corresponding to the one or more second access points in the network.

13. The method of claim 12, wherein a neighborhood in the network is specified in the query frame by at least one of: a basic service set identifier (BSSID) of an anchor access point; an access-point multi-link device (MLD) identifier of the anchor access point; a multi-link mobility domain (MLMD) identifier of the anchor access point; a band of frequencies; an operating class; a channel; or a basic service set (BSS) color.

14. The method of claim 13, wherein the band of frequencies, the channel, or both are different from the band of frequencies, the channel, or both used to communicate the query frame.

15. The method of claim 12, wherein the one or more second access points are specified by one or more corresponding criteria of the query frame.

16. The method of claim 15, wherein the one or more criteria comprise a quality-of-service (QOS) metric or a received signal strength indication (RSSI) criterion.

17. A second electronic device, comprising:
an antenna node configured to communicatively couple to an antenna; and
an interface circuit, communicatively coupled to the antenna node, configured to communicate with an electronic device, wherein the interface circuit is configured to:
receiving, from the electronic device, a query frame that requests information corresponding to one or more access points in a network; and
providing, addressed to at least the electronic device, the response frame, based at least in part on the query frame, wherein the response frame comprises second information corresponding to the one or more second access points in the network.

18. The second electronic device of claim 17, wherein a neighborhood in the network is specified in the query frame by at least one of: a basic service set identifier (BSSID) of an anchor access point; an access-point multi-link device (MLD) identifier of the anchor access point; a multi-link mobility domain (MLMD) identifier of the anchor access point; a band of frequencies; an operating class; a channel; or a basic service set (BSS) color.

19. The second electronic device of claim 18, wherein the band of frequencies, the channel, or both are different from the band of frequencies, the channel, or both used to communicate the query frame.

20. The second electronic device of claim 17, wherein the one or more second access points are specified by one or more corresponding criteria in the query frame.
